(19) United States
(12) Patent Application Publication
(10) Pub. No.: US 2009/0014005 A1
(43) Pub. Date: Jan. 15, 2009

(54) Air filter device

(76) Inventor: Stuart MacKinnon, Halifax (CA)

Correspondence Address: HARDING, EARLEY, FOLLMER & FRAILEY, 86 THE COMMONS AT VALLEY FORGE, 1288 VALLEY FORGE ROAD, P. O. BOX 750, VALLEY FORGE, PA, 19482-0750, US

(21) Appl. No.: 12/215,425

(22) Filed: Jun. 27, 2008

(30) Foreign Application Priority Data
Jul. 11, 2007 (CA) 2,593,296

(51) Int. Cl. A62B 23/02; A42C 5/04

(52) U.S. Cl. 128/206.12; 2/171.3

(57) ABSTRACT

An air filtration device for a helmet protective face mask comprising, a filtration shield, adapted to receive at least one filter and means for securely engaging the filtration shield to the helmet protective face mask, wherein the filtration shield comprises a shape for fitting substantially snugly within an inside surface of the helmet protective face mask.

### FIELD OF THE INVENTION

The present invention relates to air filtration devices, and more particularly, relates to air filtration devices for hockey and sporting helmets and standalone filtration devices

### BACKGROUND OF THE INVENTION

Indoor hockey arenas and other indoor sporting facilities (hereinafter collectively referred to as “indoor hockey arenas”) may experience air-quality deterioration for various reasons. These reasons include: inadequate ventilation, as a result of which airborne microbes and molds, and exhaust pollutants (for example nitrogen dioxide, carbon monoxide, and particulate matter) accumulate. These pollutants from ice resurfacing equipment, edging machines, and other equipment typically found within the indoor hockey arena environment accumulate in the air within the indoor hockey arena, and may significantly negatively effect the health and performance of the users of and other attendants at the indoor hockey arena, particularly the athletes who are exposed to these airborne materials during heavy exertion and inhale more pollutants due to increased ventilation. Furthermore, as the area immediately above the ice surface is colder than air circulating above the glass level, a thermal layer is created trapping certain pollutants in the area immediately above the ice surface, coinciding with the location from which athletes draw air.

In addition, the pollutants found within indoor hockey arenas include fine particulate matter (“FPM”), and ultra-fine particulate matter (“UFPM”), both which may readily be deposited in the human lung and have the ability to penetrate the lung tissues and to spread by way of the bloodstream to other organ systems. These pollutants increase the risk of harm or injury to athletes and other attendants at indoor hockey arenas who are exposed thereto.

It is therefore desirable to provide athletes and others who may be exposed to these pollutants, with a device to reduce their intake of such pollutants.

### SUMMARY OF THE INVENTION

Accordingly, one object of the present invention is to provide an effective and easy to use air filtration device adapted to be used by hockey players, athletes and other users of indoor hockey arenas.

According to one aspect of the present invention, there is provided an air filtration device for a helmet protective face mask comprising, a filtration shield, adapted to receive at least one filter and means for temporarily and securely engaging the filtration shield to the helmet protective face mask.

According to another aspect of the present invention, there is provided an air filtration device comprising a filtration shield shaped to fit substantially snugly over a user's mouth and nose, the filtration shield comprising a perforated housing for temporarily positioning at least one filter there within and straps for temporarily and securely engaging the filtration shield to the user's head.

The advantage of the present invention is that it provides an effective and easy to use air filtration device adapted to be used by hockey players, athletes and other users of indoor arenas.

### BRIEF DESCRIPTION OF THE DRAWINGS

A preferred embodiment of the present invention is described below with reference to the accompanying drawings, in which:

FIG. 1 is a side view of a typical metal wire cage type mask;

FIG. 2 is a side view of a filtration shield of one embodiment of the present invention;

FIG. 3A is a side view of the filtration shield of one embodiment of the present invention, positioned within a typical metal wire cage type mask;

FIG. 3B is a side view of the filtration shield of FIG. 3A securely fastened within the metal wire cage type mask;

FIG. 4A is a top view, partially in cross-section, of a filtration shield of one embodiment of the present invention positioned within a metal wire cage type mask;

FIG. 4B is a top view, partially in cross-section, of a filtration shield of one embodiment of the present invention positioned within a metal wire cage type mask, the filtration shield having positioned therewithin, two filters;

FIG. 5A is a front view, partially in ghost, of a filtration shield of one embodiment of the present invention;

FIG. 5B is a front view of a filtration shield of one embodiment of the present invention;

FIG. 5C is a front view of a filter for use within a filtration shield of one embodiment of the present invention.

### DESCRIPTION OF THE PREFERRED EMBODIMENT

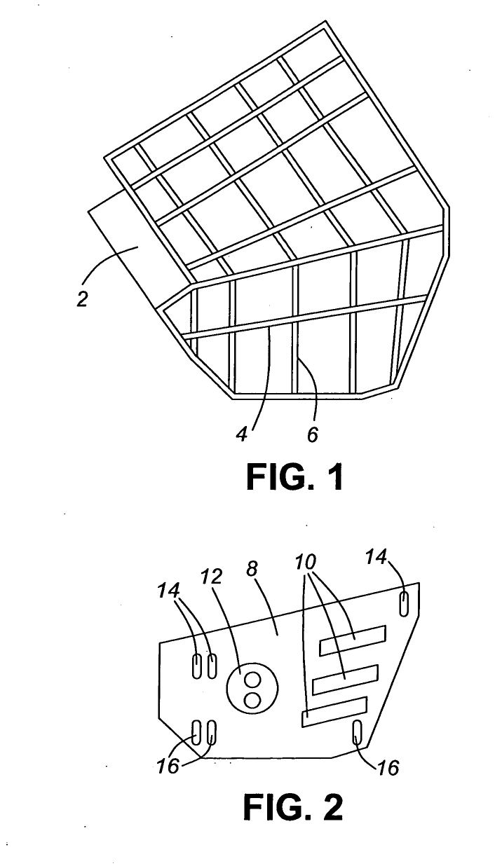

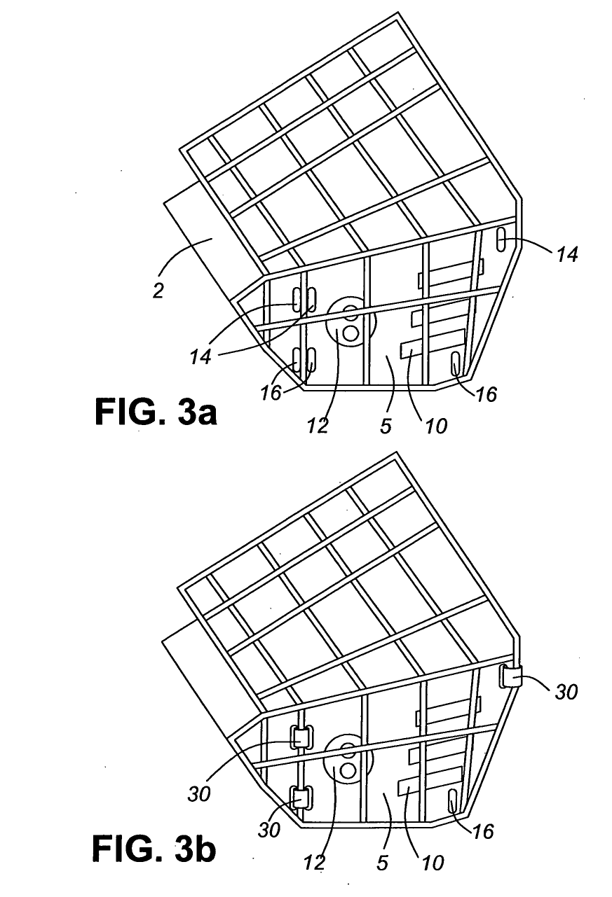

Modem hockey helmets may generally be fitted with one of three different types of hockey masks, namely, metal wire cage type masks 2, such as illustrated in FIG. 1, having a grid of wires 4 and 6 to protect of the wearers face, for attachment to the front of a hockey helmet; full facial coverage high-impact polycarbonate transparent shields, for attachment to the front of a hockey helmet; and partial facial coverage high-impact polycarbonate transparent shields for attachment to the front of a hockey helmet. These masks are generally securely fitted to the helmet to provide the athlete with protection to some or all of the facial area when in use.

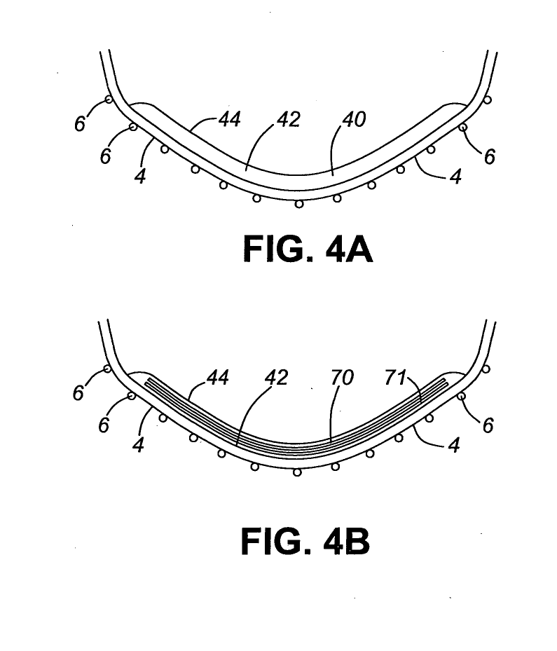

In a preferred embodiment of the present invention, as illustrated in FIGS. 2, 4A, 4B, 5A and 5B, a filtration shield 8 is provided for attachment inside of the metal wire cage type mask 2, the filtration shield 8 being of a shape and size for insertion into and secure and removable attachment to the metal wire cage type mask 2, the filtration shield 8 preferably being rigid or semi-rigid plastic or polycarbonate and, as illustrated in FIG. 4A and 4B having a front wall 42 and rear wall 44 surrounding an elongated cavity 40 having a support floor 41 adapted to receive and temporarily position there within one or more filters or filter membranes, and preferably a charcoal filter and a HEPA filter as more fully described herein. The precise shape of the filtration shield 8 is such that it fits snugly within the inside surface of the mask and is of a size and shape to limit interference with the user's vision, it being understood that differently sized, configured and shaped filtration shields may be utilized, depending upon the size, shape and configuration of the metal wire cage type mask 2.

In a preferred embodiment of the present invention, the filtration shield will be positioned inside of and substantially proximate the wires of the metal wire cage type mask, and in the case of those metal wire cage type masks having a chin cup, positioned between the wires of the metal wire cage type mask and the chin cup.

In a preferred embodiment of the present invention, to securely and temporarily fasten the filtration shield 8 to the metal wire cage type mask 2, strap holes 14 and 16 are provided in the filtration shield 8 through which strap holes 14 and 16, short lengths of Velcro™ strap or similar straps 30 may be inserted so that the straps 30, passing through the strap holes 14 and 16 and 20 around one of the wires 6 of the metal wire cage type mask 2, to securely and temporarily fasten the filtration shield 8 to the metal wire cage type mask 2, it being understood that various different methods and materials may be used to securely and temporarily fasten the filtration shield 8 to the metal wire cage type mask 2 as would be known to a person skilled in the art. In one embodiment of the present invention, the mask's chin strap may also be passed through holes 16 to provide additional fastenment of the filtration shield to the metal wire cage type mask.

In a preferred embodiment of the present invention, the filtration shield 8 has inhalation slots 10 or other holes in the front wall 42 thereof to allow the passage of air from outside of the mask area, through the elongated cavity 40 and through the one or more filters positioned therewithin, and, out through rear wall slots 11 in the rear wall 44 into the area proximate the wearer's mouth and nose, and has one or more one way exhalation valves 12 therethrough to permit the passage of exhausted air from the area proximate the wearer's mouth and nose to an area outside of the mask area. In use, as the user inhales, the user creates an area of relative negative pressure proximate the inside of the rear wall 44 of the filtration shield 8, drawing air from outside the mask area, through the slots 10 and the elongated cavity 40 and through the one or more filters positioned therewithin, which filtered air then passes through the rear wall slots 11 in the rear wall 44 and is then available for inhalation by the user. As the user exhales, the user creates an area of relative positive pressure proximate the user's nose and mouth, which air is exhausted from the mask by way of the exhalation valves 12 to an area outside of the mask area. In this way, as the user breathes, intake air is filtered, and exhaust air is displaced from the mask area.

In one embodiment of the present invention, a filter shield for high-impact polycarbonate transparent face shields (hereinafter “polycarbonate full face shields”) is provided, which polycarbonate full face shields have air vents therein, through which air is inhaled and exhaled by the user during use. The filter shield, in this embodiment of the present invention, is of a size and configuration to fit snugly within the polycarbonate full face shield, and may be securely and temporarily fastened thereto by means of Velcro tape or such other means as would be known to a person skilled in the art, and is positioned within the polycarbonate full face shield so that the inhalation slots and exhalation valves are positioned over or closely proximate to the pre-existing air vents in the polycarbonate full face shield.

In one embodiment of the present invention, where the individual is using either a partial poly carbonate shield (shielding only the upper portion of the user's face), or where the individual is not wearing any face protection at all (for example, figure skaters and speed skaters), or where the user has severe asthma, exercise induced bronchospasm (“EIB”) or other respiratory ailment, the filter shield is of a generally triangular shape and made of a soft flexible material, shaped to fit snugly over the user's mouth and nose, and utilizes and incorporates a soft flexible perforated neoprene housing that will attached to the individual's head by means of Velcro straps, or by such other means as would be known to a person skilled in the art. In this embodiment of the present invention, the filter shield covers the user's mouth and nostrils (nares), a soft seal being provided between the filter shield and the user's face and nose to reduce or eliminate the passage of unfiltered air into the area immediately proximate the user's mouth and nostrils.

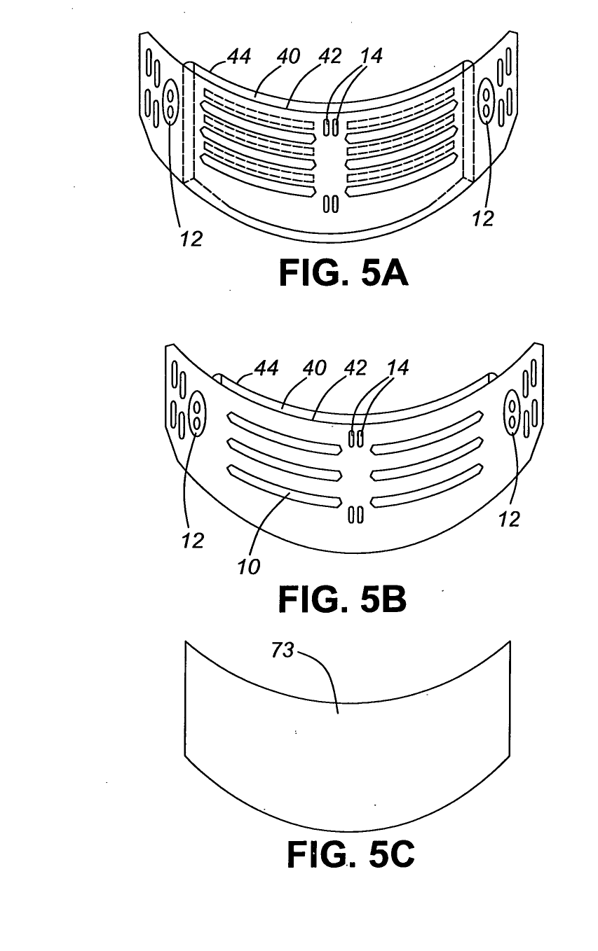

As previously referenced, one or more filters 70 and 71, and preferably an activated charcoal filter 71 (for the removal of volatile organic compounds, such as the noxious gases produced by the partial combustion of fossil fuels, and mold mycotoxins from the air), and a HEPA filter 70 (that is, a highly efficient particulate arrested filter adapted to remove 99.97 percent of airborne pollutants 0.3 micrometers or larger in size) may be positioned within the elongated cavity 40, the filters being of a size and shape to snugly and securely rest within the elongated cavity 40 during use. In an alternative embodiment of the present invention, one or more filters (such as an activated charcoal filter, and a HEPA filter) may be combined and surrounded within a porous mesh to form a single multi-filter membrane 73 such as illustrated in FIG. 5C is provided for insertion into the elongated cavity 40. In one embodiment of the present invention, a ULPA filter 71 (an ultra low penetration air filter adapted to remove 99.99 percent of airborne pollutants 0.12 micrometers or larger in size) is also provided for insertion into the elongated cavity 40.

In an alternative embodiment of the present invention, one or more filters, may be positioned over one or more holes in a mask, and securely affixed in that position to the mask by means of tape or other fastener as would be known to a person skilled in the art.

The present invention has been described herein with regard to preferred embodiments. However, it will be obvious to persons skilled in the art that a number of variations and modifications can be made without departing from the scope of the invention as described herein.

What is claimed is:

1. An air filtration device for a helmet protective face mask comprising:
a. a filtration shield, adapted to receive at least one filter;
b. means for securely engaging the filtration shield to the helmet protective face mask.

2. An air filtration device as defined in claim 1 wherein the filtration shield comprises means for temporarily positioning the at least one filter.

3. An air filtration device as defined in claim 2 wherein the filtration shield comprises a front wall and a rear wall surrounding an elongated cavity having a bottom support, the cavity for temporarily positioning the at least one filter there within.

4. An air filtration device as defined in claim 3 wherein the at least one filter are combined forming a single multi-filter membrane for insertion into the elongated cavity.

5. An air filtration device as defined in claim 1 wherein the filtration shield comprises at least an inhalation opening for enabling passage of outside air through the at least one filter and at least one one way exhalation valve placed outside the at least one filter for enabling passage of exhausted air from an area proximate a wearer's mouth and nose to an area outside of the helmet protective face mask.

6. An air filtration device as defined in claim 1 wherein the filtration shield comprises a shape for fitting substantially snugly within an inside surface of the helmet protective face mask.

7. An air filtration device as defined in claim 1 wherein the means for securely engaging the filtration shield to the helmet protective face mask comprise openings disposed in the filtration shield, the openings for enabling passage of straps there through for fastening the filtration shield to the helmet protective face mask.

8. An air filtration device comprising:
a. a filtration shield shaped to fit substantially snugly over a user's mouth and nose, the filtration shield comprising a perforated housing for temporarily positioning at least one filter there within;
b. straps for temporarily and securely engaging the filtration shield to the user's head.

9. An air filtration device as defined in claim 8 comprising a soft seal for being disposed between the filter shield and the user's head for reducing passage of unfiltered air into an area proximate to the user's mouth and nostrils.

10. An air filtration device as defined in claim 8 wherein the housing comprises a front wall and a rear wall surrounding an elongated cavity having a bottom support.
